(19) United States
(12) Patent Application Publication
(10) Pub. No.: US 2005/0071208 A1
(43) Pub. Date: Mar. 31, 2005

(54) Open architecture technology platform having front end administratively driven delivery management system

(76) Inventors: Danamichele Brennen, Philadelphia, PA (US); Kevin Franklin Maurer, Philadelphia, PA (US); Gianna M. Christodoulou, Philadelphia, PA (US)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 10/673,697

(22) Filed: Sep. 29, 2003

(51) Int. Cl. G06F 17/60

(52) U.S. Cl. 705/7

(57) ABSTRACT

A technology platform for implementing a plurality of programs. Each program has a program manager, is offered to a user and is supported by supporting suppliers/venders. The platform includes a management system including an interface which is adapted to authenticate the program manager of each program, authenticate the user of each program, and authenticate the supporting suppliers/venders of each program. A service provider gateway links a service provider to the management system. The gateway permits the service provider to access and control selected program information. The service provider engages the supporting suppliers/venders to support the program. Non-supporting suppliers/vendors can obtain benchmarking information.

### TECHNICAL FIELD

Embodiments of the present invention relate to the field of technology platforms. In particular, embodiments of this invention relate to an open architecture technology platform having a front end administratively driven delivery management system (1) through which a user can initiate and review a program, (2) through which suppliers/venders can support a program and obtain benchmarking information, and (3) through which associates (including program managers) can access and manage a program.

### BACKGROUND OF THE INVENTION

In order to fulfill requirements of certain regulations and in order to promote sales, suppliers of drugs frequently bring together internal sales people, physicians and other professionals to learn about or evaluate their new drugs. In the past, such gatherings have been organized and managed on a case-by-case basis. Although this type of management has been successful, it is time intensive, can be costly and is prone to errors.

There is a need for a system which increases the efficiency and effectiveness of meetings management, from pharmaceutical meetings such as grand rounds, dinner meetings and grant requests to launches and advisory boards. In addition, there is a need for efficient and effective control of honorarium checks and financial reporting relating to such meetings. There is also a need for such a system which interfaces with existing technology which may be controlled and/or used by multiple parties involved in the meeting planning activities.

### SUMMARY OF THE INVENTION

The invention meets the above needs and provides a system and method which permits companies to plan and/or manage their meetings in order to reduce their meeting expenses. The invention also provides a system and method which enables executives to control meeting spending while optimizing compliance with code requirements and company specific policies. Further, the invention provides one point of contact for meeting planners such as pharmaceutical sales representatives thereby enabling representatives to increase their productivity gain and helping companies to consolidate spend data. Further, the invention streamlines physician honorarium processing with a turnkey solution that provides efficient and effective honorarium payment, expense reimbursement and financial reporting services. The method and system is designed to ease the strain on sales representatives, accounts payable and customer resource professionals responsible for responding to physician inquiries regarding the timeliness of receiving honorarium checks and expense reimbursements. In addition, the method and system effectively eliminates high internal labor cost for check distribution and assists corporations with Federal Government year end reporting.

In accordance with one aspect of the invention, a technology platform implements a plurality of programs, each having a program manager, wherein each program is offered to a user and is supported by supporting suppliers/venders. A management system includes an interface which is adapted to authenticate the program manager of each program, authenticate the user of each program, and authenticate the supporting suppliers/venders of each program. The management system permits (1) the user to initiate a program and review selected program information of programs for which the user is authorized to access; (2) the supporting suppliers/venders to monitor selected program information of programs which the supporting suppliers/venders are authorized to access; and (3) the program manager to manage a program and to access selected program information of programs for which the program manager is authorized to access. A service provider gateway links a service provider to the management system. The gateway permits the service provider to access and control selected program information. The service provider engages the supporting suppliers/venders to support the program.

In accordance with another aspect of the invention, a technology platform implements a physician services program including meetings of physicians offered by a sales representative of drug suppliers wherein the meetings are supported by suppliers/venders. A meeting operations center (MOC) administers the program. A registration engine linked to the meeting operations center registers physicians for the meetings. A portal permits the sales representatives and the drug suppliers to access the meeting operation center to schedule meetings. The suppliers/venders access the meeting operation center through the portal to support the meetings.

In accordance with another aspect of the invention, a technology platform for implementing meetings of a program offered by a central meeting planner to users wherein the meetings are supported by suppliers/venders. A meeting operations center administers the program. A registration engine linked to the meeting operations center registers attendees of the meetings. A portal permits the central meeting planner and the users to access the meeting operation center to schedule meetings. The suppliers/venders access the meeting operation center through the portal to support the meetings.

In accordance with another aspect of the invention, a method implements a plurality of programs, each having a program manager, wherein each program is offered to a user and is supported by supporting suppliers/venders. The program manager of each program, the user of each program, and supporting suppliers/venders of each program are authenticated. The user is permitted to initiate a program and review selected program information of programs for which the user is authorized to access. The supporting suppliers/venders is permitted to monitor selected program information of programs which the supporting suppliers/venders are authorized to access. The program manager is permitted to manage a program and to access selected program information of programs for which the program manager is authorized to access. A service provider is permitted to access and control selected program information, wherein the service provider engages the supporting suppliers/venders to support the program.

In accordance with another aspect of the invention, a method provides for benchmarking information relating to a plurality of programs. Each program has a program manager and is offered to a user and is supported by supporting suppliers/venders. The user is permitted to initiate a program and review selected program information of programs for which the user is authorized to access. The program manager is permitted to manage a program and to access selected program information of programs for which the program manager is authorized to access. The method comprises the steps of:
permitting the supporting suppliers/venders to monitor selected program information of programs which the supporting suppliers/venders are authorized to access;
permitting a service provider to access and control selected program information, wherein the service provider engages the supporting suppliers/venders to support the program; and
authenticating non-supporting suppliers/venders of each program and permitting the authenticated non-supporting suppliers/venders to access selected program information for benchmarking of programs which information the non-supporting suppliers/venders are authorized to access.

Alternatively, the invention may comprise various other methods and apparatuses.

Other features will be in part apparent and in part pointed out hereinafter.

### BRIEF DESCRIPTION OF THE DRAWINGS

FIG. 1 is an exemplary block diagram of one preferred embodiment of an open architecture technology platform having a front end administratively driven delivery management system according to the invention.

FIG. 2 is an exemplary flow diagram illustrating the data flow of the platform of FIG. 1.

FIGS. 3A and 3B are an exemplary flow diagram illustrating more detailed data flow of an MOC embodiment of the platform of FIG. 1.

FIG. 4 is an exemplary flow diagram illustrating the data flow of a physician services program (PSP) embodiment of the platform of FIG. 1.

FIG. 4A is a block diagram illustrating the architecture of the database of FIG. 4 combining both the MOC and the PPS.

FIG. 5 is an exemplary block diagram illustrating one preferred embodiment of an implementation of a program for planning and/or managing meetings by the open architecture technology platform having a front end administratively driven delivery management system according to the invention.

FIG. 6 is a diagram illustrating the functionality of a physician services program (PSP) implemented by an open architecture technology platform having a front end administratively driven delivery management system according to the invention.

FIG. 7 is a diagram illustrating the functionality of a dining services program implemented by an open architecture technology platform having a front end administratively driven delivery management system according to the invention.

### SUMMARY OF THE APPENDICES

Appendix A is a summary of one embodiment of hardware which may be employed to implement the platform of the invention.

Appendix B is a technology overview one embodiment of physical and network security which may be employed with the platform of the invention.

Appendix C is a description of a meeting portal which may be used as part of one embodiment of a front end administratively driven delivery management system of the platform of the invention.

Appendix D is a description of specifications of one embodiment of a data exchange and MOC server which may be employed to implement the platform according to the invention.

### DETAILED DESCRIPTION OF THE INVENTION

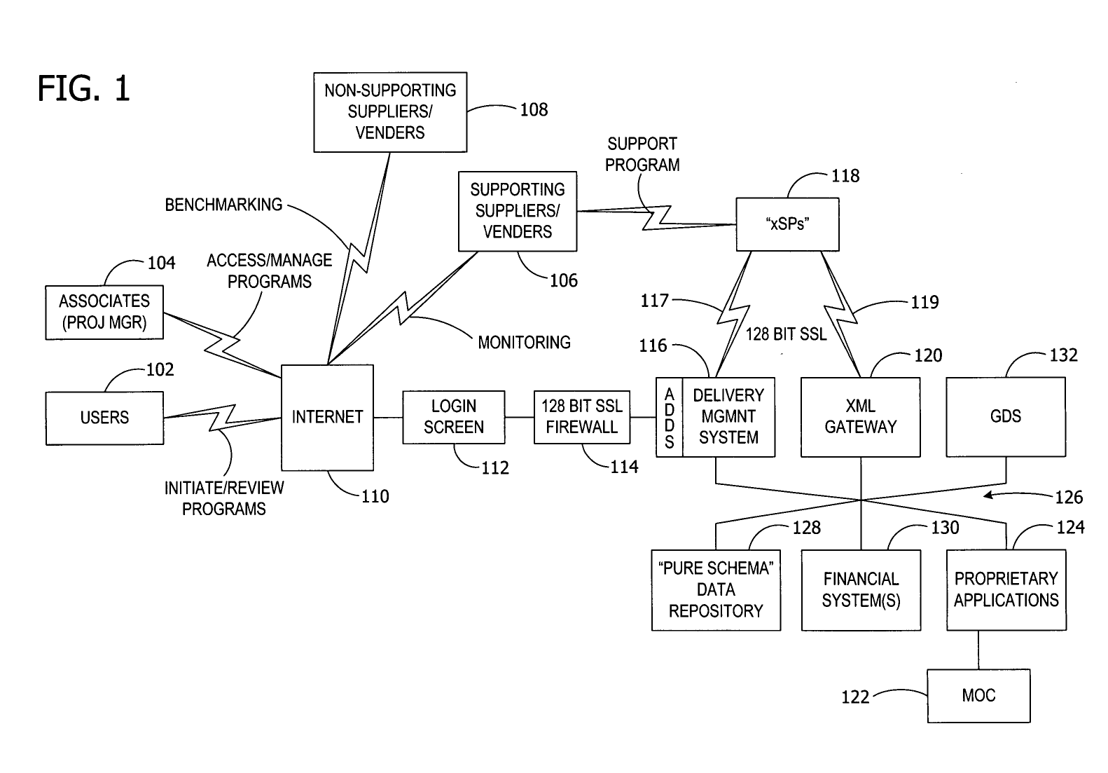

Referring first to FIG. 1, an exemplary block diagram of one preferred embodiment of an open architecture technology platform 100 for implementing a plurality of programs. In general, a program includes meetings, seminars or any other event that requires advance planning. Each program has a program manager 104 which manages the program. The programs are offered to and are frequently initiated by a user 102, such as an employee of pharmaceutical company. Each program is supported by supporting suppliers/venders 106 who provide services relating to the program, such as meeting rooms, food, video equipment or other goods or services needed for the program. The platform includes a front end administratively driven delivery management system 116, in general, manages the delivery of information, manages which users have access to particular information, manages functions, and manages which users can employ particular functions.

The management system 116 includes an interface (e.g., login screen 112 and firewall 114) which is adapted to authenticate the program manager 104 of each program, authenticate the user 102 of each program, and authenticate the supporting suppliers/venders 106 of each program. The management system 116 is configured to permit the user 102 to initiate a program and review selected program information of programs for which the user is authorized to access. The management system 116 is also configured to permit the supporting suppliers/venders 106 to monitor selected program information of programs which the supporting suppliers/venders 106 are authorized to access. The management system 116 is also configured to permit the program manager 104 to manage a program and to access selected program information of programs for which the program manager is authorized to access.

The platform also includes a service provider gateway linking one or more service providers 118 to the management system 116. The gateway may be a direct link 117 as illustrated in FIG. 1 or it may be an indirect link 119 via an XML gateway 120. The gateway permits the service provider 118 to interface and interact with selected program information. The service provider 118 engages the supporting suppliers/venders 106 to support the program. The supporting suppliers/venders 106 may access the management system 116 via the service provider 118 (as illustrated in FIG. 1) or via the Internet 110.

The management system 116 also authenticates non-supporting suppliers/venders 108 of each program and permits the authenticated non-supporting suppliers/venders 108 to access selected program information for obtaining benchmarking information from the programs. For example, the management system permits the non-supporting suppliers/venders to access certain information which they are authorized to access in order to evaluate the progress of certain programs in order to more effectively determine how they can compete and/or become supporting suppliers/venders 106. Other benchmarking information may include historic spend levels and percentages compared to others.

As shown in FIG. 1, the platform 100 is accessible by users 102 such as clients who will initiate a program or review an existing program, associates 104 (such as program managers) who will access and manage programs, supporting suppliers/venders 106 who will monitor programs so that they are able to support the programs and non-supporting suppliers/venders who will access program information for benchmarking. This access is through an Internet interface 110 which facilitates providing information or receiving information. This access provides significant advantages and flexibility because it does not require installing anything on the desktops of either associates, users or suppliers/venders so that they can access information and/or applications whether or not they are out in the field, on a client site or internally—all that is needed is that they have an internet connection.

It is contemplated that the communication may be secured through a VPN. Basically, all they need is a browser and internet access to get to the platform 100. The log in screen 112 is in front of a firewall 114 and uses 128 bit secure socket layer (SSL) encryption to get to the platform 100.

In one embodiment, many of the platform features implemented are non-proprietary, off-the-self components that are plugged into this architecture to make it leading edge and flexible with the lowest total cost of ownership. This unique approach takes advantage of web services and emerging internet-based commerce and technology delivery mechanisms but also offers to users leading edge technology now and in the future at the lowest total cost of ownership.

The first part of the technology platform 100 which is relevant is the delivery management system 116. Depending on the functional role that a person is fulfilling, e.g., an associate, a user, or a supplier/vender looking to interact some way with the platform 100 or to get data, the person initially logs in to a screen 112 and based on their user name and password, the management system 116 interprets who they are and from that point forward gives them a dynamic web page with buttons providing further selected access to information and applications behind the firewall 114. The buttons represent tools and functions relevant to and/or corresponding to the role of the person.

The management system is a commercially available piece of software by IT4 called Pointspace and is accessed/used, in fact, as an ASP, an application service provider. This system 116 is the delivery mechanism to associates, users and suppliers/venders so that the platform 100 provides secure delivery and access to them from virtually any location with access to the Internet 110.

Once the management system 116 knows who someone is from the login screen 112, it will give them access to various different pieces of information. Access levels can be defined in a variety of ways.

Depending on their role and responsibility, and the services that their corporation has purchased, people may be given access to one or more strategic service providers (XSPs) 118. XSPs is a term which improves on the term “ASP” (application service provider) by referring to the notion that it is not just applications that are being plugged and played by corporations around the world. It could be any service, not just applications. So hence the use of an “x” instead of an “a” in the term XSPs. It is contemplated that the platform owner could have strategic partnerships with XSPs such as Starcite, bethere.com, ez-event.com., and it4. As a result, the management system 116 provides a seamless, single sign on (SSO) for someone who has logged in to the management system 116. The system 116 automatically and securely through the 128 SSL firewall 114 connects them to each XSP that they have been given access to and the rights to.

Data uploads and downloads to the XSPs 118 are accomplished as is necessary for them to do their job on the back end of the platform 100 via 119 and the XML gateway 120 or directly via 117. So, for example, while an associate or program manager 104 is doing some meeting planning or data analysis, the management system 116 pushes up to these XSPs 118 a certain set of data that they need to perform their services. The system 116 pulls the data and related data added by the XSP 118 back down after utilizing the XSP applications/services. In other words, after the XSPs 118 do the task at hand, the system 116 pulls data back down, through the XML gateway 120. The XML gateway 120 tags the data which may have various labels depending on the XSP 118 so that it can be consistently used by the system architecture and merged with other system data.

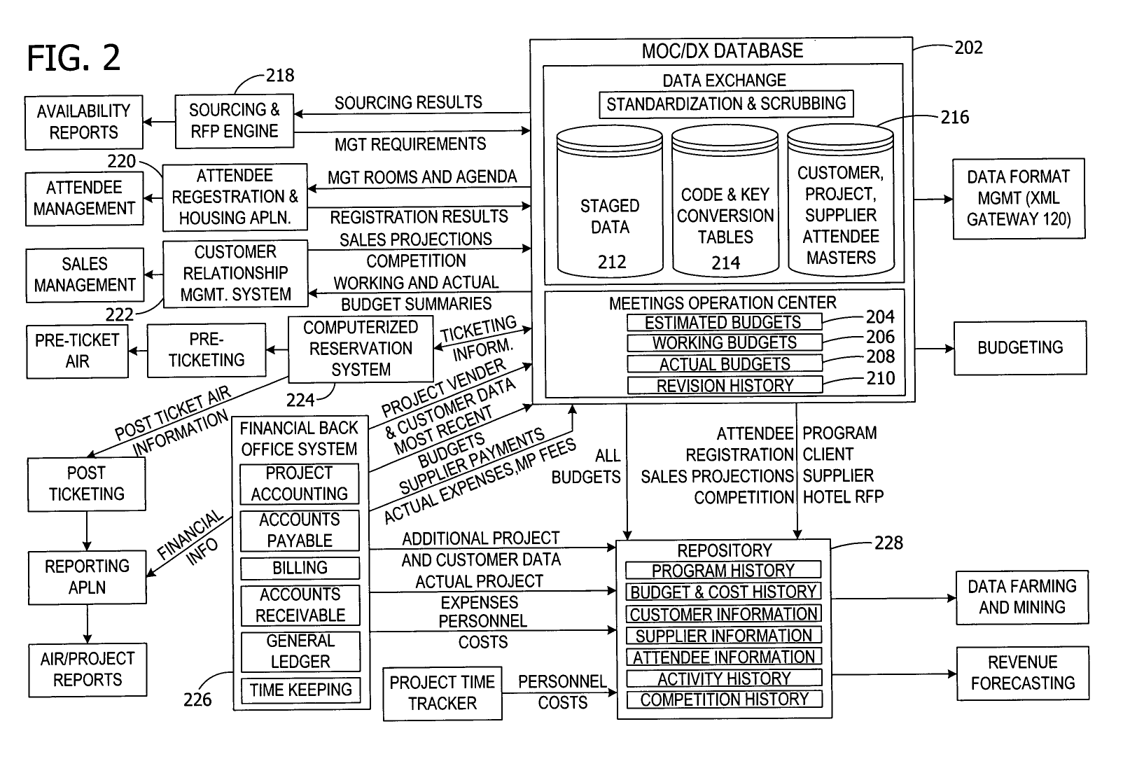

In some embodiments of the system, it is contemplated that the XSPs 118 are remote from the system 116. The servers of the XSPs 118 may be in one location which is different than the servers of the management system 116. In any case, the platform 100 appears seamless to not only the associates 104 but also the users and to the suppliers/venders 106, 108. In many instances, what is going on behind the firewall 114 is not really relevant to them as long as they are able to perform their desired functions. Thus, the data is both pushed and pulled on the back side with these XSPs 118 and all of these activities centralize or aggregate in a meetings operation center 122 (MOC; see FIG. 2), which may be implemented as a proprietary application 124.

The MOC 122 is the hub or the central aggregation point for all of the activities that a meeting planner consolidates and aggregates. For example, such activities include budgeting, actuals, charges, attendees and meeting agendas. In addition, the MOC 116 provides the interface between the meeting planner and one or more XSPs 118 via 117 or via 119 and the XML gateway 120 and it pulls data back down into the MOC from the XSPs 118 via the gateway 120 as needed so that it can complete its tasks. In one embodiment, the platform 100 is an open architecture platform making use of a flexible administratively driven delivery mechanism (ADDS) through the management system 116 as a front door for everyone.

The management is administrative so that web pages are not programmed based on a client or associate or supplier. The management system 116 enables the platform to administratively present dynamic web pages for all of these potential users. The platform 100 also allows integrated XSPs and allows for continued integration of XSPs so that the best in class will be able to added over time. The XSPs 118 connected to the platform 100 now and additional numbers of XSPs in the future that can connect for the same benefits allows the platform 100 to take advantage of what the marketplace has to offer in terms of new functionalities, best in class functionalities, even client-based system functionalities. In general, the platform 100 could interface with unlimited XSPs in this same way.

The proprietary applications 124 focus on the core value propositions for platform owners which are not otherwise available from XSPs in order to aggregate the meeting planning information and enable financial performance analysis no matter who is “touching” pieces of business are being conducted. The financial performance metrics about savings and benchmarks are managed by the MOC 122 and the PSP system (see FIG. 2), respectively.

The interconnections 126 between the various components of the platform indicate that the components plug and play from a work flow perspective.

Another component of one embodiment of this architecture is a pure schema data repository 128. This may be an SQL 2000 data repository and it is in fact a pure play data schema, i.e., an application independent data store. Although there may be multiple different applications used by not only the platform owner but also by users based on how the platform owner serves the users, a pure play data repository 128 is important because it is not wrapped up in any particular business rules or issues surrounding any particular application. The XML tagging by the XML gateway 120 creates a scenario where a pure play schema can be present in the data repository and accessed by data warehousing and data mining tools, and the pivot tools. The SQL tools that are on top of the SQL 2000 database are easy and flexible and robust for anyone to utilize whether or not it is an associate 104, a user 102 or supplier/venders 106, 108.

For example, if someone accesses the platform through the Internet 110, login screen 112 and firewall 114 into the management system 116 and they have been given access or further click throughs, to the pure play data repository, they will also be given rights to certain data cubes. This is a tremendous way for them to access and drill down on their historic data. The MOC 122 (and the PSP system of FIG. 2) utilize SQL 2000 database structures for the current data but when that data becomes historic (e.g., the program has ended or meeting has occurred, billed or been assessed), it is transferred into the pure play data repository 128. Thus, the platform differentiates between an application and a historic consolidated data source.

In one embodiment, a financial system 130, such as a system by Oracle, CMS, PAS or Solomon, plugs into the architecture of this platform 100 for managing financial processes and check writing. The platform 100 also optionally interfaces with a global distribution system 132 (GDS) such as an Apollo Galileo or Sabre system for travel logistics, planning, booking and data consolidation. In general, the platform has an open and flexible architecture so that pieces may be pulled out and replaced in order to improve economies of scale and scope and/or performance.

In summary, in one embodiment, an important aspect of the open architecture of the platform 100 is the combination of leading edge administratively driven delivery mechanism through the internet, all secure. In another embodiment, the plug and play of XSPs by client and by person is an important aspect. In another embodiment, the utilization of an XML tagging mechanism to push data up to these XSPs as needed and pull it back down is an important aspect. In another embodiment, the proprietary applications can be a hub for the users to pull all of these things together into one working process which is the meetings operation center 122 as well as the PSP system (FIG. 2) which is a variant of the MOC 122. Also, in another embodiment, the pure play data repository provides a data warehouse which is separate from all applications and an important aspect.

Referring next to FIG. 2, this diagram is a high level view of the data flow between the various components of FIG.1 in the context of a physician services program (PSP). A meeting operations center data exchange (MOC/DX) database 202 maintains estimated budgets 204, working budgets 206, actual budgets 208 and budget revision history 210. In addition, database 202 shows staged data 212, code and key conversion tables 214 and customer project, supplier attendee master tables and data 216. The PSP system could also include check management routines (e.g., a physician payment system-PPS) and speaker management databases.

The data exchange aspect of the database 202 includes standardization and scrubbing of data per the XML tags. Many of the aspects to the left of the database 202 illustrate the push and pull of data, high level requirements, and sourcing results between a sourcing and RFP engine 218, an attendee registration and housing application 220 and a customer relationship management system 222, as well as some interaction with a computerized reservation system 224. There is also some interaction between the database 202 and a financial back office system 226 for project vender and customer data. In addition, the database 202 pushes historic information into a repository 228. Appendix D describes specifications of one embodiment of such a data exchange and MOC server which may be employed to implement the platform 100.

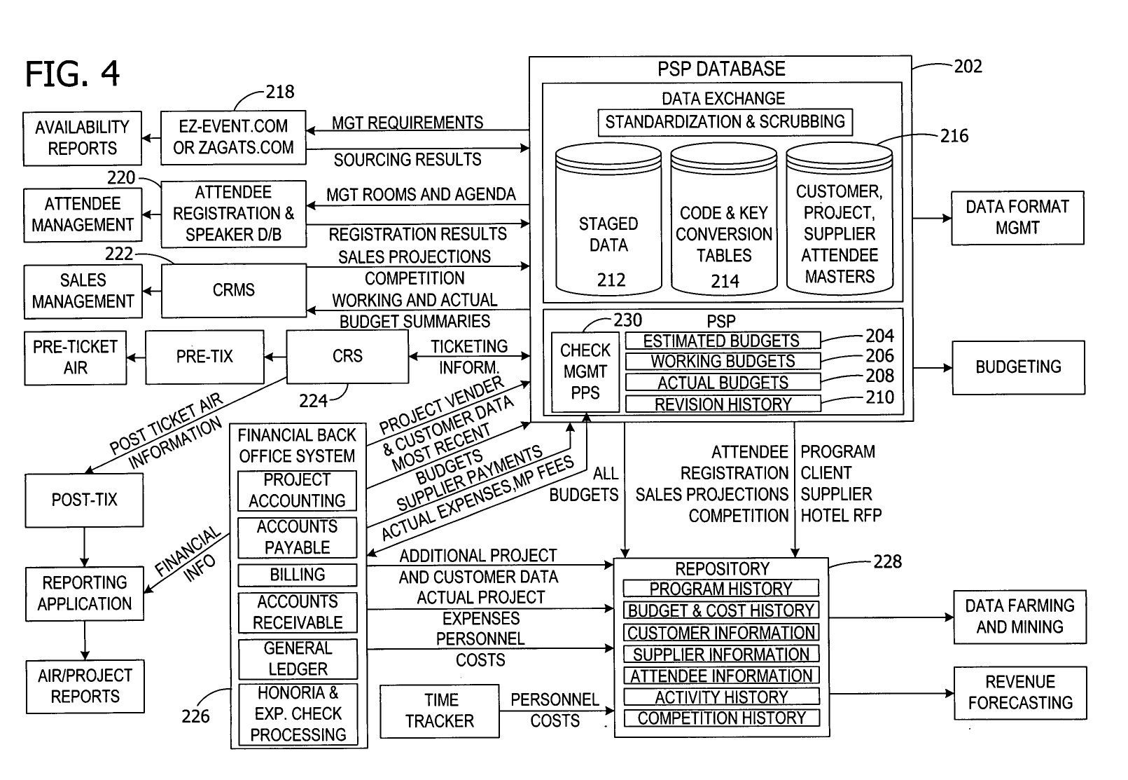

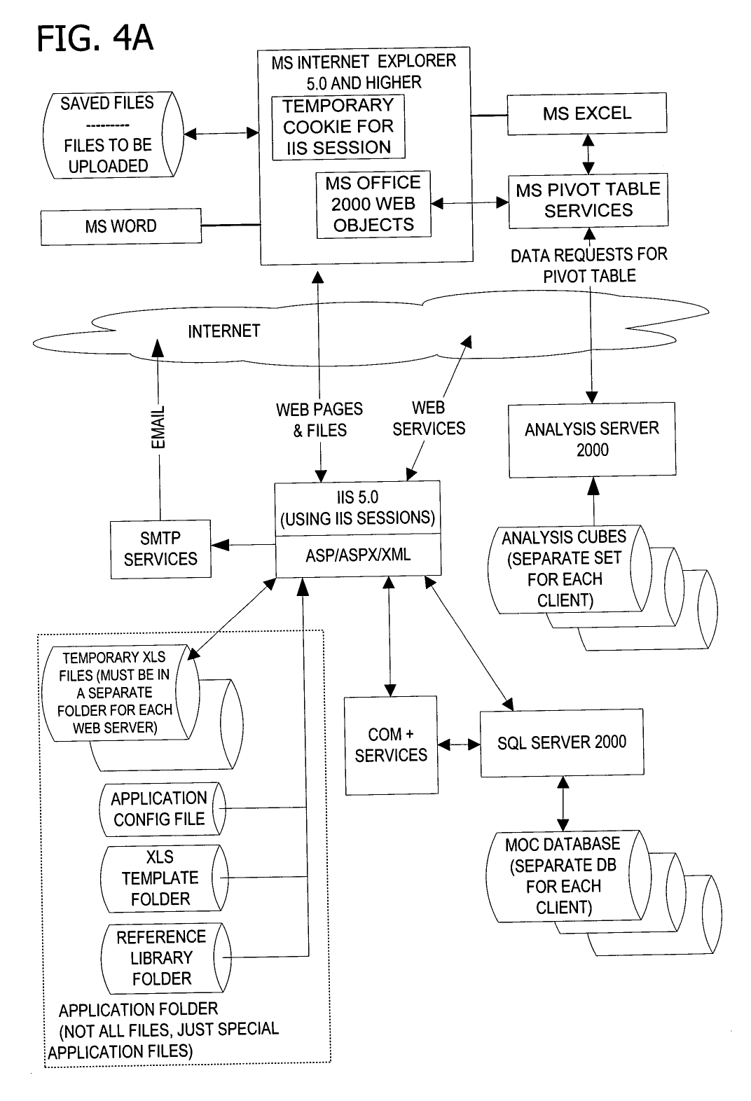

FIG. 4 is an exemplary flow diagram illustrating the data flow of a physician services program (PSP) embodiment of the platform of FIG. 1. FIG. 4 illustrates a variant of the MOC interfacing with the financial back office system 226 and the repository 228 but has basically the same components as the MOC and it could interface with EZ-event.com or zagats.com in an XSP capacity as the sourcing and rfp (request for proposal) engine 218. Thus, FIG. 2 reflects the high level data flow that is going on between these components, the XSPs, the proprietary applications, and the repository. This figure does not illustrate the delivery mechanism but it begins to show how with certain client configurations of utilizing this technology platform, the client would be able to plug and play the various different pieces to achieve the desired functionality. Further, the platform owner is able to replace piecemeal the different parts as is illustrated by the acquisition by platform owner leading to the replacement of the financial systems, attendee registration and XSPs as well as the CRS systems. In addition, a physician payment system (PPS) for check management 232 has been illustrated as part of the PSP database 202. FIG. 4A illustrates one embodiment of the combined architecture of the MOC and PPS.

In summary, the MOC functions for hubbing, piecing together and plug and playing with the various different parts. Similarly, PSP supports the physician services program and incorporates a speaker, a bureau management piece, and leverages the management system delivery mechanism as it interfaces with thousands of sales reps. It could also integrate with the dining venue sourcing systems and interface with the financial system for check cutting. Alternatively, off-the-shelf check cutting applications and other infrastructure may replace Solomon.

Referring again to FIG. 1, another aspect of one embodiment of the PSP system as well as the MOC that is not shown in FIG. 2 is the open architecture technology platform diagram. FIG. 2 illustrates some of the high level data schema that is trading all this data back and forth in the various systems. Another important aspect in line with the lowest total cost of ownership of leading edge, plug and play and open architecture is the accessibility of the most recent data to either associates, clients or suppliers. Accessing data through this architecture allows each entity to find the most recent data, whether or not the data is in the pure play repository or whether or not there is more current data in the MOC or the PSP. The MOC and the PSP system have a feature which allows entities to check budgets and data in and out of the system and manipulate it in a spreadsheet tool such as EXCEL or in a pivot tool so that they can manipulate and massage and generate reports with the data inside and chart the data using spreadsheet tools which are likely to already be on most desktops, and which most people already know how to use. It does not require training to use the data or to look at it. Sometimes, the data cubes and pivot tools require a little bit of training. The cubes that come out of the repository can be slightly more complex but anybody who knows Excel is a very quick study and it's a very comfortable application for them to work in.

Another important aspect of this embodiment is that whether or not an associate or client or supplier, manipulates data in Excel, they do not run the risk of permanently corrupting or erasing the original source data. This includes meeting planning companies who might be “pulling out” budgets that have been put together through sourcing activities. At some point, it is contemplated that any or all will check data back in to the platform. Since they have checked out the data and manipulated it, checking it back in means the supplied data will change. However, there is no risk of data corruption in the data repository because data is saved in different versions. For example, budgets are saved in various forms depending on date and format, and the entities that created or modified the versions.

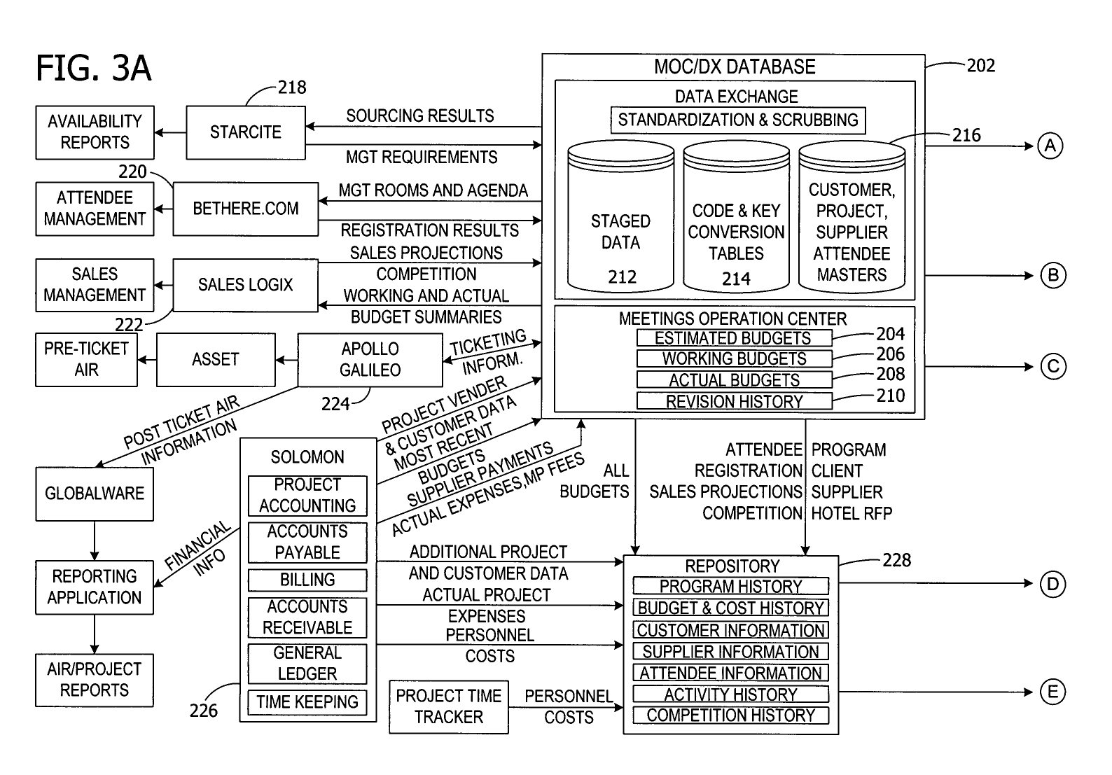

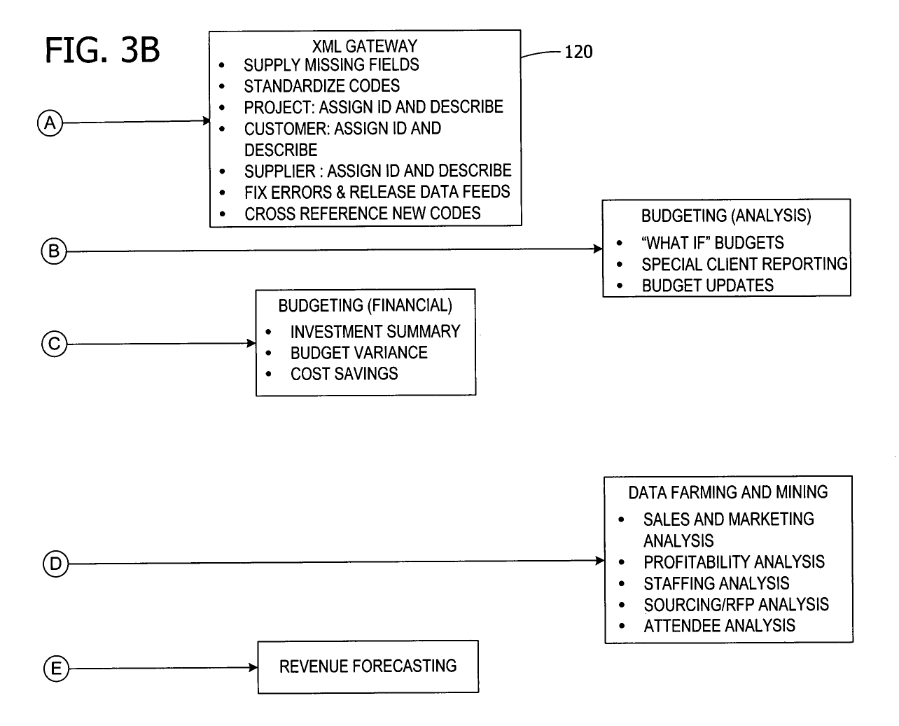

FIGS. 3A and 3B are an exemplary flow diagram illustrating the data flow of an MOC embodiment of the platform of FIG. 1. In FIG. 3A, the sourcing and RFP engine 218 is illustrated as Starcite.com and the attendee registration and housing application 220 as bethere.com. Sales Logix is the application employed for the customer relationship management system 222 and Apollo Galileo is the application for the computerized reservation system 224. Solomon is illustrated as the financial back office system 226. Those skilled in the art will recognize other applications, off-the-self systems and configurations that may be employed in addition to or in place of these.

In FIG. 3B, the XML gateway 120 supplies missing data fields, standardizes codes, assigns identification codes to projects, customers and suppliers, adds a description field describing projects, customers and suppliers, fixes data errors and releases data feeds and cross references new codes. Budgeting includes analysis relating to “what if” budgets, special client reporting, and budget updates, and financial details of investment summaries, budget variances and cost savings. Data farming and mining includes, among other things, sales and marketing, profitability, staffing, sourcing/rfp and attendee analysis.

The PSP system of FIG. 4 is the MOC version specifically used in the physician services program or PSP. The PSP architecture is mirrored after the MOC but it has the additional functionality of managing speaker bureaus for pharmaceutical companies as well as driving and interfacing with a financial system for driving honorary and expense checks.

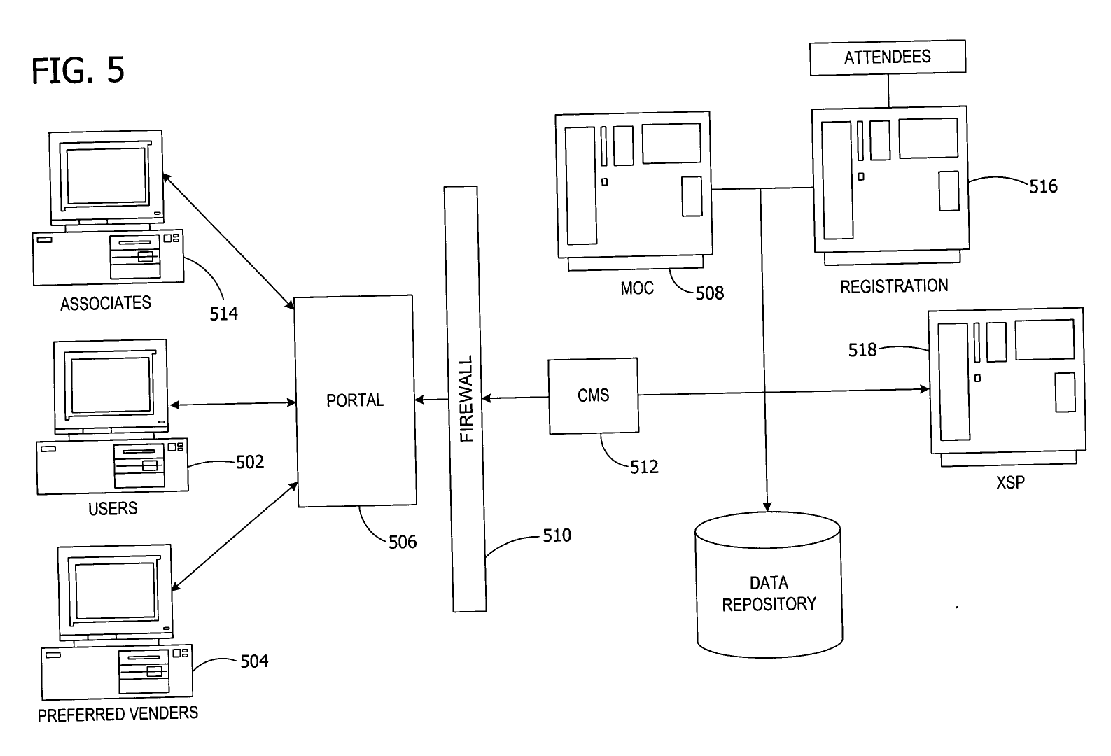

Referring next to FIG. 5, a client view is illustrated of one embodiment of how the architecture of FIG. 1 may be used at a high level for managing meetings. The meeting may be organized by a user 502 such as a central meeting planning group user inside an organization or on site, or a user elsewhere or a preferred vender 504 who is actually doing the meeting planning for the organization's meetings. The user 502 does the sourcing for all of the meetings and the preferred venders 504 execute the logistics of the meetings. So our approach here is that everybody, again, accesses a portal 506 to a platform 508 which maintains the information. Appendix C describes one such meeting portal which may be used as part of one embodiment of a front end administratively driven delivery management system of the platform 100.

Once someone gets through a firewall 510 of the platform 508, they are identified and connected to a management system 512 which gives them access rights to meeting planning functions related to their role. They can manipulate and use the data at will or check it back in to operate in the meetings operation center as a user 502 or as an associate 514 or to access a registration engine 516, such as bethere.com. The registration engine 516 enables the creation of an attendee registration website and then facilitates the capture of the registration information as attendees are added to the meeting. An XSP 518 such as Starcite would interface with the MOC 508, the CMS 512, the registration engine 516 and the data repository for the purposes of facilitating the finding, interacting and contracting with hotel venues at which to conduct the meeting being planned.

All data comes from and is provided to a data repository 516 for consolidated reporting. The repository 516 is accessible to all parties: users 502, venders 504 and associates 514. It is also contemplated that behind the firewall 510 may be a PSP system and/or a PSP product offering with the honorarium check processing, etc. This flexible technology architecture is a very successful methodology for supporting customers because it pulls together things that have in the past not been pulled together in any systematic fashion. For example, it integrates such activities as sourcing, data management, registrations, budget setting and XSPs which add value and efficiency to the process of meeting planning.

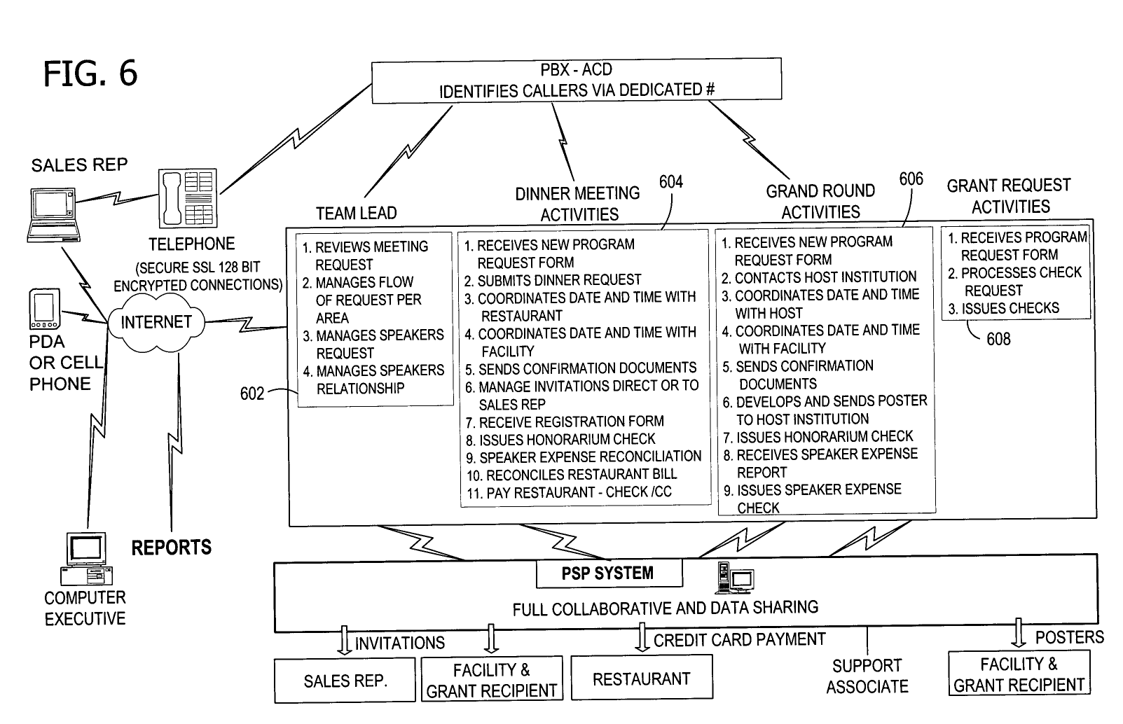

Referring next to FIG. 6, a high level view of how the components of FIG. 1 get pulled together for the delivery of the physician services program (PSP) is illustrated. As noted above, a portal is utilized as a sales reps interface with the call center, which utilizes the platform and refers to components of it in this diagram as a fully collaborative and data sharing system. The delivery infrastructure, e.g., IT4 Pointspace allows large numbers of sales reps to come in and place meeting requests. It interfaces with a financial system, e.g., Solomon, for the check cutting; it includes speaker bureau management; and it interfaces with a meeting planner. A team lead performs the four functions listed in box 602. In one aspect, reviewing meeting requests 1 includes registering meetings and assigning program numbers. Managing flow of request per area 2 includes dinner meetings, grand rounds, grant requests and other aspects. Managing speaker relationships 4 includes coordinating speaker availability and resolving schedule conflicts. A person overseeing dinner meeting activities performs the 11 functions listed in box 604. In one aspect, sending confirmation documents 5 includes sending documents to attendees and to speakers (including expense reimbursement forms). A person overseeing grand round activities performs the functions listed in box 606. In one aspect, sending confirmation documents 5 includes sending documents to the host institution and to the speaker (including expense reimbursement forms). A person overseeing grant request activities performs the functions listed in box 608.

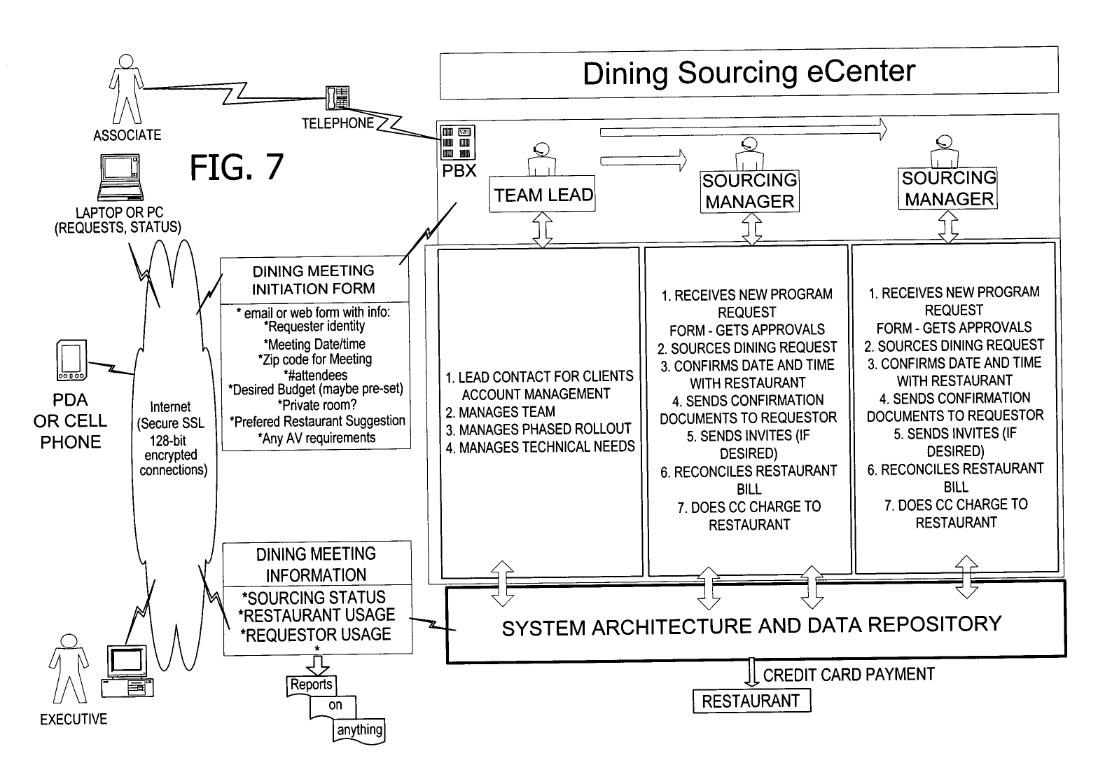

Referring next to FIG. 7, it illustrates a generic view of a system similar to the PSP system which may be used by other industries. For example, the automotive industry would use the system of FIG. 7 as a dining sourcing e-center. The left side illustrates that all of the requesters of dining meetings go through the delivery infrastructure to log in, to put in requests to the dining sourcing e-center. The system architecture and data repository operates all of this business and interface with the client and stores the data in the pure play data repository. For the auto industry, for example, this system is able to pull together via an open architecture a consolidated sourcing and data collection product offering as is shown on this diagram.

Those skilled in the art will note that the order of execution or performance of the methods illustrated and described herein is not essential, unless otherwise specified. That is, it is contemplated by the inventors that elements of the methods may be performed in any order, unless otherwise specified, and that the methods may include more or less elements than those disclosed herein.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. A technology platform for implementing a plurality of programs, each having a program manager, wherein each program is offered to a user and is supported by supporting suppliers/venders, said platform comprising: a management system including an interface which is adapted to authenticate the program manager of each program, authenticate the user of each program, and authenticate the supporting suppliers/venders of each program, said management system permitting:
(1) the user to initiate a program and review selected program information of programs for which the user is authorized to access;
(2) the supporting suppliers/venders to monitor selected program information of programs which the supporting suppliers/venders are authorized to access;
(3) the program manager to manage a program and to access selected program information of programs for which the program manager is authorized to access; and
a service provider gateway linking a service provider to the management system, said gateway for permitting the service provider to access and control selected program information, wherein the service provider engages the supporting suppliers/venders to support the program.

2. The platform of claim 1 wherein the management system comprises a front end administratively driven delivery management system for managing users and managing functions.

3. The platform of claim 1 wherein the management system authenticates non-supporting suppliers/venders of each program and permits the authenticated non-supporting suppliers/venders to access selected program information for benchmarking of programs.

4. The platform of claim 1 wherein the management system interfaces with a network and wherein the user, the suppliers/venders and the program manager access the delivery system via the network.

5. The platform of claim 4 wherein the network is selected from an intranet and a global network.

6. The platform of claim 1 wherein the management system presents a unique dynamic web page to each of the user, the suppliers/venders and the program manager and wherein the content of the dynamic web page corresponds to the user, the supplier/vender and the program manager to which it is presented.

7. The platform of claim 1 further comprising a data repository accessible to the user, the suppliers/venders and the program manager via the management system and wherein the management system presents particular data from the repository as a function of the user, the suppliers/venders and the program manager requesting the particular data.

8. The platform of claim 1 further comprising a data repository accessible to the user, the suppliers/venders and the program manager via the management system and an XML tagging system for pushing data from the repository to the service providers and for pulling data from the service providers to the repository.

9. The platform of claim 1 further comprising a proprietary application gateway linked to the management system for providing a second service relating to a particular program and wherein the user, the supporting suppliers/venders and the program manager access the proprietary application through the administratively driven delivery system.

10. The platform of claim 9 wherein the proprietary application comprises a physician's services program for administering meeting between physicians and users.

11. The platform of claim 9 wherein the proprietary application comprises a meeting operation center (MOC) for scheduling and coordinating meetings and their follow-up relating to the program.

12. The platform of claim 11 further comprising a data repository and wherein the management system includes a meetings operation center MOC including an MOC database within the data repository storing staged data of the various stages of the program, conversion tables for converting data in compatible formats and attendee masters tables which are used for monitoring programs.

13. The platform of claim 12 wherein the user, the suppliers/venders and the program managers each access a unique set of selected data in the data repository via the management system and wherein the associates, user and suppliers/venders each access a unique set of data in the MOC and physician payment system via the management system.

14. The platform of claim 11 wherein the MOC maintains estimated, working and/or actual budgets for the program and revision history of budgets during the course of the program.

15. The platform of claim 11 wherein the MOC includes a data exchange for standardizing and scrubbing data in the MOC database by applying XML tags to corresponding data that is pushed or pulled through the MOC.

16. The platform of claim 11 wherein the service provider comprises a meeting manager pulling data relating to meeting requirements from data repository via the MOC and pushing data relating to sourcing results to the data repository via the MOC.

17. The platform of claim 11 wherein the service provider comprises an attendee registration engine pulling data relating to meeting rooms and agendas from the data repository via the MOC and pushing data relating to registration results to the data repository via the MOC.

18. The platform of claim 11 wherein the service provider comprises a sales manager pulling data relating to sales projections and competition from the data repository via the MOC and pushing working and/or actual budget summaries to the data repository via the MOC.

19. The platform of claim 11 wherein the service provider comprises a global distribution system pulling data relating to ticketing information from the data repository via the MOC and pushing data relating to ticketing information to the data repository via the MOC.

20. The platform of claim 11 further comprising a data repository and wherein the MOC database pushes historic information to the data repository.

21. The platform of claim 11 further comprising a physician payment system interfacing with the MOC.

22. The platform of claim 1 wherein the service provider comprises a global distribution system interfacing with the management system for managing travel.

23. The platform of claim 1 further comprising a financial system interfacing with the management system for monitoring financial transactions related to the program.

24. A technology platform for implementing a physician services program including meetings of physicians offered by a sales representative of drug suppliers wherein the meetings are supported by suppliers/venders, said platform comprising:
a meeting operations center (MOC) for administering the program;
a registration engine linked to the meeting operations center for registering physicians for the meetings;
a portal through which the sales representatives and the drug suppliers access the meeting operation center to schedule meetings and through which the suppliers/venders access the meeting operation center to support the meetings.

25. The platform of claim 24 wherein the MOC comprises a front end administratively driven delivery management system for managing users and managing functions.

26. The platform of claim 24 wherein the MOC authenticates non-supporting suppliers/venders of each program and permits the authenticated non-supporting suppliers/venders to access selected program information for benchmarking of programs.

27. The platform of claim 24 wherein the MOC presents a unique dynamic web page to each of the user, the suppliers/venders and the program manager and wherein the content of the dynamic web page corresponds to the user, the supplier/vender and the program manager to which it is presented.

28. The platform of claim 24 further comprising a data repository accessible to the user, the suppliers/venders and the program manager via the MOC and wherein the MOC presents particular data from the repository as a function of the user, the suppliers/venders and the program manager requesting the particular data.

29. The platform of claim 24 further comprising a data repository accessible to the user, the suppliers/venders and the program manager via the MOC and an XML tagging system for pushing data from the repository to the service providers and for pulling data from the service providers to the repository.

30. The platform of claim 24 further comprising a proprietary application gateway linked to the MOC for providing a second service relating to a particular program and wherein the user, the supporting suppliers/venders and the program manager access the proprietary application through the administratively driven delivery system.

31. The platform of claim 30 wherein the proprietary application comprises a physician's services program for administering meeting between physicians and users.

32. The platform of claim 30 wherein the proprietary application comprises a meeting operation center (MOC) for scheduling and coordinating meetings and their follow-up relating to the program.

33. The platform of claim 32 wherein the MOC includes a data exchange for standardizing and scrubbing data in the MOC database by applying XML tags to corresponding data that is pushed or pulled through the MOC.

34. The platform of claim 32 wherein the user, the suppliers/venders and the program managers each access a unique set of selected data in the data repository via the MOC and wherein the associates, user and suppliers/venders each access a unique set of data in the MOC and access a physician payment system via the MOC.

35. The platform of claim 24 wherein the service provider comprises a global distribution system interfacing with the MOC for managing travel.

36. The platform of claim 24 further comprising a financial system interfacing with the MOC for monitoring financial transactions related to the program.

37. A technology platform for implementing meetings of a program offered by a central meeting planner to users wherein the meetings are supported by suppliers/venders, said platform comprising:
a meeting operations center for administering the program;
a registration engine linked to the meeting operations center for registering attendees of the meetings;
a portal through which the central meeting planner and the users access the meeting operation center to schedule meetings and through which the suppliers/venders access the meeting operation center to support the meetings.

38. A method for implementing a plurality of programs, each having a program manager, wherein each program is offered to a user and is supported by supporting suppliers/venders, said method comprising the steps of:
authenticating the program manager of each program,
authenticating the user of each program,
authenticating the supporting suppliers/venders of each program;
permitting the user to initiate a program and review selected program information of programs for which the user is authorized to access;
permitting the supporting suppliers/venders to monitor selected program information of programs which the supporting suppliers/venders are authorized to access;
permitting the program manager to manage a program and to access selected program information of programs for which the program manager is authorized to access; and
permitting a service provider to access and control selected program information, wherein the service provider engages the supporting suppliers/venders to support the program.

39. The method of claim 38 further comprising managing users and managing functions.

40. The method of claim 38 further comprising authenticating non-supporting suppliers/venders of each program and permitting the authenticated non-supporting suppliers/venders to access selected program information for benchmarking of programs.

41. The method of claim 38 further comprising presenting a unique dynamic web page to each of the user, the suppliers/venders and the program manager and wherein the content of the dynamic web page corresponds to the user, the supplier/vender and the program manager to which it is presented.

42. The method of claim 38 further comprising permitting the user, the suppliers/venders and the program manager access particular data from a data repository as a function of the user, the suppliers/venders and the program manager requesting the particular data.

43. The method of claim 38 further comprising permitting the user, the suppliers/venders and the program manager to access data and XML tagging data from a repository to the service providers and XML tagging data from the service providers to the repository.

44. The method of claim 38 further comprising linking a proprietary application gateway for providing a second service relating to a particular program and wherein the user, the supporting suppliers/venders and the program manager access the proprietary application through an administratively driven delivery system.

45. The method of claim 44 wherein the proprietary application comprises a physician's services program for administering meeting between physicians and users.

46. The method of claim 44 wherein the proprietary application comprises a meeting operation center (MOC) for scheduling and coordinating meetings and their follow-up relating to the program.

47. The method of claim 46 wherein the MOC includes a data exchange for standardizing and scrubbing data in the MOC database by applying XML tags to corresponding data that is pushed or pulled through the MOC.

48. The method of claim 46 wherein the user, the suppliers/venders and the program managers each access a unique set of selected data in the data repository via the MOC and wherein the associates, user and suppliers/venders each access a unique set of data in the MOC and access a physician payment system via the MOC.

49. The method of claim 38 interfacing with a management system for managing travel and monitoring financial transactions related to the program.

50. A method for providing benchmarking information relating to a plurality of programs, each having a program manager, wherein each program is offered to a user and is supported by supporting suppliers/venders, wherein the user is permitted to initiate a program and review selected program information of programs for which the user is authorized to access and wherein the program manager is permitted to manage a program and to access selected program information of programs for which the program manager is authorized to access; said method comprising the steps of:
permitting the supporting suppliers/venders to monitor selected program information of programs which the supporting suppliers/venders are authorized to access;
permitting a service provider to access and control selected program information, wherein the service provider engages the supporting suppliers/venders to support the program; and
authenticating non-supporting suppliers/venders of each program and permitting the authenticated non-supporting suppliers/venders to access selected program information for benchmarking of programs which information the non-supporting suppliers/venders are authorized to access.
